(19) United States
(12) Patent Application Publication
(10) Pub. No.: US 2022/0058175 A1
(43) Pub. Date: Feb. 24, 2022

(54) DATA ANALYSIS APPARATUS, DATA ANALYSYS METHOD, AND PROGRAM

(71) Applicant: NEC Corporation, Minato-ku, Tokyo (JP)

(72) Inventor: Ryohto SAWADA, Tokyo (JP)

(73) Assignee: NEC Corporation, Minato-ku, Tokyo (JP)

(21) Appl. No.: 17/275,411

(22) PCT Filed: Sep. 12, 2019
(86) PCT No.: PCT/JP2019/035964

§ 371 Date: Mar. 11, 2021

(30) Foreign Application Priority Data
Sep. 13, 2018 (JP) 2018-171381

(51) Int. Cl. G06F 16/23; G06N 5/02

(52) U.S. Cl. CPC G06F 16/2365; G06N 5/02

(57) ABSTRACT

To assist a person to make an appropriate action plan based on multi-dimensional data. A data analysis apparatus includes an input part which receives first multi-dimensional data made up by a set of multi-dimensional vectors; a calculation part which divides a first multi-dimensional space spanned by the first multi-dimensional data into a second multi-dimensional space(s), interpolates second multi-dimensional data forming the second multi-dimensional space(s) among the first multi-dimensional data, and estimates a regression model(s); and an analysis part which determines whether or not there is a deficiency in the first multi-dimensional data based on an estimation result of the regression model(s).

### REFERENCE TO RELATED APPLICATION

This application is a National Stage Entry of PCT/JP2019/035964 filed on Sep. 12, 2019, which claims priority from Japanese Patent Application 2018-171381 filed on Sep. 13, 2018, the contents of all of which are incorporated herein by reference, in their entirety. The present invention relates to a data analysis apparatus, a data analysis method, and a program.

### FIELD

### Background

Multi-dimensional data analyses (so called a big data analysis) are demanded in fields of science, marketing and so on for analyzing data obtained by experiments and market research and establishing research or sales guidelines. In these multi-dimensional data analyses, it becomes necessary to deal with non-linear elements such as correlations between data.

Along with recent development of computer technologies, it is becoming possible to make action plans by analyzing multi-dimensional data (hereinafter also called “input”) using a non-linear model.

Patent Literature (PTL) 1 discloses a technology to receive multi-dimensional data and estimate a mixture model from the received multi-dimensional data. In the technology described in PTL 1, an optimal mixture model is estimated by optimizing types and parameters of components constituting the mixture model that is a target for estimating.

Non-Patent Literature (NPL) 1 discloses a technology in which, in a game of Go, multi-dimensional data of a face of a board of a game of Go is analyzed by a multi-layered neural network and select measures in such a manner that an estimated winning rate is maximized.

NPL 2 discloses a technology to estimate transition of power consumption from multi-dimensional data relating to time, weather and so on using a mixture alternate week model.
PTL 1: WO2012/128207A1
NPL 1: Mastering the game of Go without human knowledge, Nature volume 550, pages 354-359 (19 Oct. 2017)
NPL 2: Ryohei Fujimaki, Satoshi Morinaga, “The Most Advanced Data Mining of the Big Data Era”, NEC Technical Journal Vol. 65 No. 2, September, 2012, p 81-85

### SUMMARY

The disclosure of each of the above Patent Literatures and Non-Patent Literature is incorporated herein by reference thereto. The following analysis has been given from a view of the present invention.

As described above, multi-dimensional data analyses (so called a big data analysis) are demanded for analyzing data obtained by experiments and market research and establishing research or sales guidelines. However, if interpretation of analysis is not appropriate, it is difficult to make action plans (for example, research guidelines and sales guidelines). For example, it is assumed to be desired that dead stock of commercial products is reduced by adjusting supply of commercial products in response to changes in distribution by making and analyzing a database of purchasing histories and so on of customers at supermarkets and so on. However, if it is difficult for human beings to understand analysis results, it may become difficult to adjust supply of commercial products in response to changes in distribution based on the analysis result.

Furthermore, there is a case where data obtained by experiments and market research may be running short of necessary data for making action plans. For example, to make action plans, although it is important to take ages of customers into consideration, it is difficult to make appropriate action plans when information about ages is not included in the obtained data.

In the technology described in NPL 1, it is difficult for huma beings to interpret a regression result because the regression is performed by a multi-layer neural network.

In technologies described in PTL 1 and PLT 2, it is not described to determine whether or not the received multi-dimensional data is sufficient for making action plans.

Accordingly, it is an object of the present invention to provide a data analysis apparatus, a data analysis method and a program which contribute to assist a person in making appropriate action plans based on multi-dimensional data.

According to a first aspect, there is provided a data analysis apparatus. The data analysis apparatus includes an input part which receives first multi-dimensional data made up by a set of multi-dimensional vectors.

Furthermore, the data analysis apparatus includes a calculation part which divides a first multi-dimensional space spanned by the first multi-dimensional data into a second multi-dimensional space(s), interpolates second multi-dimensional data forming the second multi-dimensional space(s) among the first multi-dimensional data, and estimates a regression model(s) of the second multi-dimensional data.
Furthermore, the data analysis apparatus includes an analysis part which determines whether or not there is a deficiency in the first multi-dimensional data based on the regression model(s).

According to a second aspect, there is provided a data analysis method. The data analysis method includes receiving first multi-dimensional data made up by a set of multi-dimensional vectors.

Furthermore, the data analysis method incudes dividing a first multi-dimensional space spanned by the first multi-dimensional data into a second multi-dimensional space(s), interpolating second multi-dimensional data forming the second multi-dimensional space(s) among the first multi-dimensional data, and estimating a regression model(s) of the second multi-dimensional data.
Furthermore, the data analysis method incudes determining whether or not there is a deficiency in the first multi-dimensional data based on the regression model(s).
The present method is tied to a particular machine, namely, a data analysis apparatus which analyzes multi-dimensional data.

According to a third aspect, there is provided a program. The program causes a computer to execute a processing of receiving first multi-dimensional data made up by a set of multi-dimensional vectors. The program causes the computer to execute a processing of dividing a first multi-dimensional space spanned by the first multi-dimensional data into a second multi-dimensional space(s), interpolating second multi-dimensional data forming the second multi-dimensional space(s) among the first multi-dimensional data, and estimating a regression model(s) of the second multi-dimensional data.

The program causes the computer to execute a processing of determining whether or not there is a deficiency in data based on the regression model(s).

It is to be noted that these programs can be recorded on a computer-readable storage medium. The storage medium can be non-transient one, such as a semiconductor memory, a hard disk, a magnetic recording media, an optical recording media and so on. The present invention can be implemented as a computer program product.

According to the present invention, there are provided a data analysis apparatus, a data analysis method, and a program which contribute to assist a person in making appropriate action plans based on multi-dimensional data.

### BRIEF DESCRIPTION OF DRAWINGS

FIG. 1 illustrates an outline of an example embodiment.

FIGS. 2A and 2B illustrate an example of a regression model.

FIG. 3 shows a block diagram illustrating an example of an internal configuration of a data analysis apparatus 1.

FIG. 4 shows a flow chart illustrating an example of operation of the data analysis apparatus 1.

FIGS. 5A and 5B illustrate an example of a regression model.

FIG. 6 shows a block diagram illustrating an example of a hardware configuration of the data analysis apparatus 1.

### PREFERRED MODES[0020]

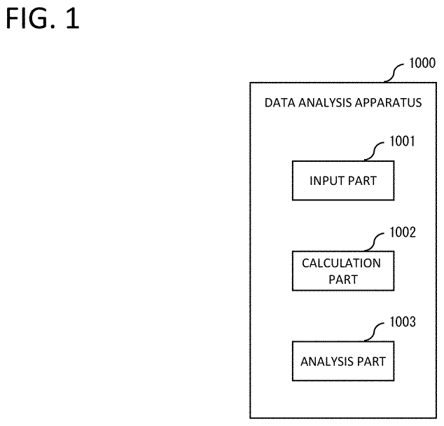

First, an outline of an example embodiment will be described with reference to FIG. 1. Note, in the following outline, reference signs of the drawings are denoted to each element as an example for the sake of convenience to facilitate understanding and description of this outline is not intended to any limitation. An individual connection line between blocks in an individual block diagram includes both one-way and two-way directions. A one-way arrow schematically illustrates a principal signal (data) flow and does not exclude bidirectionality. Furthermore, while not illustrated, an input port(s) and an output port(s) exist respectively at an input terminal(s) and an output terminal(s) of respective connection lines in circuit diagrams, block diagrams, internal configuration diagrams, connection diagrams and so on shown in the present disclosure. The same applies to an input/output interface(s).

As described above, a data analysis apparatus which contributes to assist a person in making appropriate action plans based on multi-dimensional data is desired.

Therefore, as an example, a data analysis apparatus 1000 shown in FIG. 1 is provided. The data analysis apparatus 1000 includes an input part 1001, a calculation part 1002, and an analysis part 1003.

The input part 1001 receives first multi-dimensional data made up by a set of multi-dimensional vectors (a set of N-dimensional vectors; N: a natural number). The calculation part 1002 divides a first multi-dimensional space (N-dimensional space; N: a natural number) spanned by the first multi-dimensional data into a second multi-dimensional space (M-dimensional space (M<=N); M, N: natural numbers). Then, the calculation part 1002 interpolates second multi-dimensional data (a set of M-dimensional vectors (M<=N); M, N: natural numbers) forming the second multi-dimensional space among the first multi-dimensional data, and estimates a regression model. The analysis part 1003 determines whether or not there is a deficiency in data in the first multi-dimensional data received by the input part 1001 based on an estimation result of the regression model.

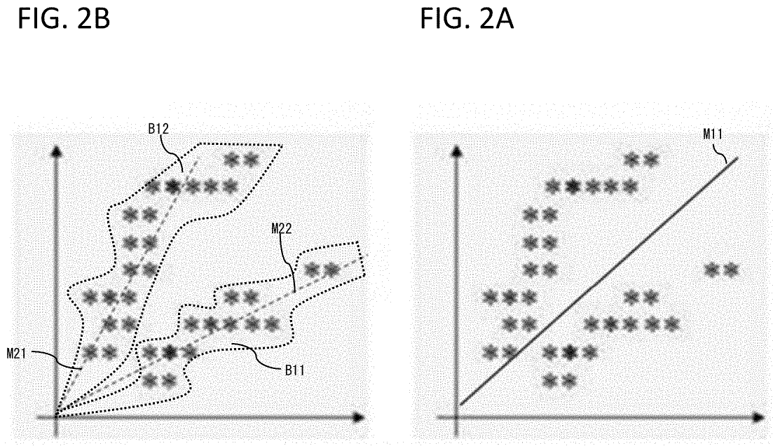

Next, an example of a regression model will be described with reference to FIGS. 2A and 2B. In FIGS. 2A and 2B, it is assumed that each point “*” in a graph is an N-dimension vector. Then, it is assumed that an entire set of points “*” in the graph is the first multi-dimensional data received by the input part 1001.

For example, with respect to the entire multi-dimensional data, when interpolating in such manner that errors from a regression model become small, a regression model such as a straight line M11 as shown in FIG. 2A is estimated. If a regression model is the straight line M11 as shown in FIG. 2A, in most areas of the multi-dimensional data, errors from the multi-dimensional data are larger than those from regression models shown in FIG. 2B (straight lines M21 and M22).

On the other hand, the calculation part 1002 of the data analysis apparatus 1000 divides the multi-dimensional space (the first multi-dimensional space) spanned by the multi-dimensional data (the first multi-dimensional data) (the entire set of points “*” in the graph shown in FIG. 2B) received by the input part 1001 into the second multi-dimensional space(s). For example, it is assumed that the calculation part 1002 divides the multi-dimensional space (the first multi-dimensional space) spanned by the multi-dimensional data (the first multi-dimensional data) (the entire set of points “*” in the graph shown in FIG. 2B) received by the input part 1001 into areas B11 and B12 surrounded by dotted lines as shown in FIG. 2B. In that case, the calculation part 1002 interpolates second multi-dimensional data forming respective divided multi-dimensional spaces (second multi-dimensional spaces) (areas B11 and B12 as shown in FIG. 2B) and estimates regression models. In other words, when interpolating the multi-dimensional data (the second multi-dimensional data) forming the area B11, the calculation part 1002 estimates a regression model by excluding the multi-dimensional data forming the area B12. In the same way, when interpolating the multi-dimensional data (the second multi-dimensional data) forming the area B12, the calculation part 1002 estimates a regression model by excluding the multi-dimensional data forming the area B11. As a result, the calculation part 1002 can estimate, for example, regression models as shown by the straight lines M21 and M22 by interpolating the multi-dimensional data forming the areas B11 and B12.

As described above, the data analysis apparatus 1000 can interpolate data so as to be easy to fall into a local solution by dividing and interpolating a multi-dimensional space spanned by multi-dimensional data and estimate a regression model. Furthermore, the data analysis apparatus 1000 contributes to avoid an erroneous action plan based on insufficient data from being made by deciding whether or not there is a deficiency in data based on an estimation result of a regression model. Therefore, the data analysis apparatus 1000 contributes to assist a person in making appropriate action plans based on multi-dimensional data.

### First Example Embodiment

A first example embodiment will be described in detail with reference to drawings.

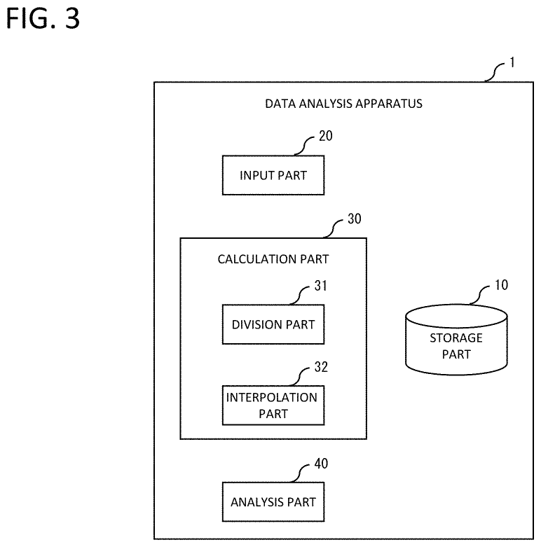

FIG. 3 shows a block diagram illustrating an example of an internal configuration of a data analysis apparatus 1 according to the present example embodiment. The data analysis apparatus 1 is configured to include a storage part 10, an input part 20, a calculation part 30, and an analysis part 40.

The storage part 10 stores multi-dimensional data made up by a multi-dimensional input and a multi-dimensional output. Here, the multi-dimensional output is data to be modeled for the multi-dimensional input. The multi-dimensional input may be pre-processed such as reducing predetermined feature values and so on if it is needed.

The storage part 10 stores a regression model estimated by the calculation part 30.

Examples of inputs and outputs are enumerated as below.

### Example 1

Inputs: Customer's age, gender, time of purchase, purchase amount, and purchased product
Output: Forecast for next or subsequent purchase

### Example 2

Input: Image data
Output: Image category

### Example 3

Input: Composition ratio of alloy materials
Output: Physical properties of alloy (magnetic, electric, and thermal and so on)

### Example 4

Input: Material characteristics
Output: Physical characteristics obtained by calculation simulations (heat, magnetism of material and so on)

The input part 20 receives first multi-dimensional data made up by a set of multi-dimensional vectors (a set of N-dimensional vectors; N: a natural number). The input part 20 stores the received first multi-dimensional data in the storage part 10.

The calculation part 30 divides a first multi-dimensional space spanned by the first multi-dimensional data into a second multi-dimensional space(s), and estimates a non-linear regression model(s). The calculation part 30 is configured to include a division part 31 and an interpolation part 32.

The division part 31 divides the first multi-dimensional space (N-dimensional space; N: a natural number) spanned by the first multi-dimensional data into the second multi-dimensional space(s) (M-dimensional space (M<=N)); M, N: natural numbers).

For example, the division part 31 may divide the multi-dimensional space spanned by the multi-dimensional data by using a random forest and repeating selection processing of parameters (that is, variables and threshold values related to a division of multi-dimensional space) related to the random forest. Concretely, when dividing using the random forest, the division part 31 may divide the multi-dimensional space spanned by the multi-dimensional data in such manner that, with respect to parameters related to the random forest (that is, variables and threshold values related to a division of multi-dimensional space), the smaller a loss function of parameters is, the higher probability the parameters are selected with. In that case, the division part 31 determines a probability function using quantum annealing or a Markov chain Monte Carlo method and so on.

Alternatively, the division part 31 may divide the multi-dimensional space spanned by the multi-dimensional data by locating a plurality of points on the multi-dimensional space and performing Voronoi tessellation according to distances from the points. Concretely, when a division is performed using Voronoi tessellation, the division part 31 may divide the multi-dimensional space spanned by the multi-dimensional data in such a manner as to move feature points (that is, parameters related to a division of the multi-dimensional space) related to the Voronoi tessellation by applying a bias in a direction to decrease the loss function. Here, a Euclidean distance or a Manhattan distance can be used as a distance between pieces of the multi-dimensional data.

The interpolation part 32 interpolates the second multi-dimensional data (M-dimensional space (M<=N)); M, N: natural numbers) forming the divided multi-dimensional space(s) (the second multi-dimensional space(s)) among the first multi-dimensional data, and estimates a regression model. The interpolation part 32 interpolates the second multi-dimensional data forming the divided multi-dimensional space(s) (the second multi-dimensional space(s)) among the first multi-dimensional data based on the loss function. Concretely, the interpolation part 32 determines a gradient of the loss function to be minimized by a monotonically decreasing function with respect to a distance from the second multi-dimensional data forming the divided multi-dimensional space(s) (the second multi-dimensional space(s)) and optimizes parameters related to a linear interpolation using a stochastic gradient descent method based on the determined gradient.

The calculation part 30 repeats multiple times a processing of dividing the multi-dimensional space spanned by the multi-dimensional data and a processing of interpolating data forming the divided multi-dimensional space(s), and estimates a regression model(s). Concretely, the calculation part 30 repeats multiple times a processing of dividing the multi-dimensional space spanned by the multi-dimensional data and a processing of interpolating data forming the divided multi-dimensional space(s) using the loss function, and estimates a model(s) to minimize a sum of the loss functions as a regression model(s).

The analysis part 40 determines whether or not there is a deficiency in the first multi-dimensional data based on the estimated regression model(s). As described above, it is assumed that necessary information means information required to make an appropriate action plan by a person. Concretely, when the calculation part 30 has estimated a plurality of regression models having different shapes, the analysis part 40 determines that there is a deficiency in the first multi-dimensional data.

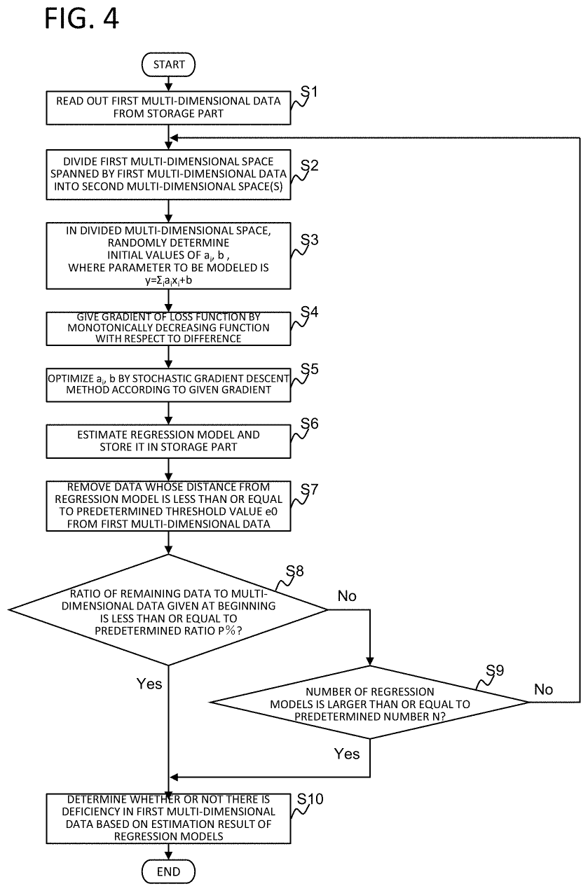

Next, with reference to FIG. 4, an operation of the data analysis apparatus 1 will be described in detail.

In step S1, the calculation part 30 reads out first multi-dimensional data from the storage part 10.

In step S2, the division part 31 divides a first multi-dimensional space spanned by the first multi-dimensional data into (a plurality of) a second multi-dimensional space. The division part 31 randomly determines a parameter(s) related to a division of the first multi-dimensional space when the first multi-dimensional space spanned by the first multi-dimensional data is divided for the first time. On the other hand, the division part 31, when the first multi-dimensional space is divided for the second or subsequent times, adjusts an adoption probability of a parameter(s) related to a division of the first multi-dimensional space in response to a value(s) of a loss function(s) corresponding to the second multi-dimensional space(s) divided up until a previous time.

In the divided multi-dimensional space (second multi-dimensional space), assume that the interpolation part 32 performs linear interpolation using expression (1), where x is an input and y is a parameter to be modeled:

y=Σᵢaᵢxᵢ+b (1)

In step S3, the division part 31, in the divided multi-dimensional space (second multi-dimensional space), randomly determines initial values of aᵢ and b, where y=Σᵢaᵢxᵢ+b.

In step S4, the interpolation part 32 gives a gradient of a loss function F by a monotonically decreasing function with respect to a difference. For example, let an input be x, let an output be y and let a difference between a regression result and y be r, the gradient of the loss function F is, for example, given as shown in expression (2). In the expression (2), e is a parameter for preventing divergence and it is preferred to be nearly e=0.01.

∂F/∂aᵢ=xᵢ/(e+rⁿ)(n>0) (2)

In step S5, the interpolation part 32 optimizes aᵢ and b by a stochastic gradient descent method, such as adagrad and so on according to the given gradient of the loss function. The interpolation part 32 may optimize aᵢ and b by performing regularization. For example, the interpolation part 32 optimizes aᵢ and b by performing L1 regularization. Thereby, it is possible to ensure sparsity.

In step S6, the calculation part 30 estimates a regression model(s) and stores same in the storage part 10. Concretely, the calculation part 30 repeats multiple times a processing of dividing the multi-dimensional space spanned by the multi-dimensional data and a processing of interpolating data forming the divided multi-dimensional space(s) using the loss function, and estimates a model(s) to minimize a sum of the loss functions as a regression model(s).

Here, the regression model which the calculation part 30 estimates does not necessarily ensure continuity. However, there is a case where it is desirable that continuity of a regression model is high even when the loss function is large (that is, error is large with respect to data obtained by experiments and market research). In such case, it is possible to increase continuity of a regression model by adding a random number to an input and an output.

In step S7, the analysis part 40 removes data (multi-dimensional vectors) whose distance from the regression model is less than or equal to a predetermined distance e0, from the first multi-dimensional data. It is assumed that e0 is an error of a regression result that is acceptable to a user. The smaller e0 is, the smaller the error from the regression model becomes, however, the lower noise immunity becomes. Therefore, it is preferable that the data analysis apparatus 1 determines e0 by repeating model searching using a plurality of e0's in such a manner that an error of a regression model is relatively small and the number of regression models is relatively small. Here, the model searching is assumed to be searching a combination of a divisional method and an interpolation method with respect to input multi-dimensional data.

In step S8, the analysis part 40 determines whether or not a ratio of remaining data (multi-dimensional vectors) to the multi-dimensional data given at the beginning (that is, the first multi-dimensional data received by the input part 20) is less than or equal to a predetermined ratio P %. It is preferable that P is nearly 10 to 30 from a view point of readability of data (easiness of interpretation in a case where a person interprets a regression result). When the ratio of the remaining data (multi-dimensional vectors) to the multi-dimensional data given at the beginning (the first multi-dimensional data) is less than or equal to a predetermined ratio P % (Yes branch of step S8), transition to step S10 occurs. On the other hand, when the ratio of remaining data (multi-dimensional vectors) to the multi-dimensional data given at the beginning exceeds a predetermined ratio P % (No branch at step S8), transition to step S9 occurs.

In step S9, the analysis part 40 determines whether or not the number of the regression models is larger than or equal to the predetermined number N. From a view point of readability of data (easiness of interpretation in a case where a person interprets a regression result), it is preferable that N is nearly 2 to 5. When the number of the regression models is larger than or equal to the predetermined number N (Yes branch at step S9), the data analysis apparatus 1 transits to step S10. On the other hand, when the number of the regression models is smaller than the predetermined number N (No branch at step S9), the operation returns to step S2 and the data analysis apparatus 1 continues processing. That is, the calculation part 30 re-estimates a regression model with respect to the first multi-dimensional data from which data (multi-dimensional vectors) whose distance from the regression model is less than or equal to e0 has been removed.

In step S10, the analysis part 40 determines whether or not there is a deficiency in the first multi-dimensional data based on the estimation result of the regression model(s). Concretely, if the calculation part 30 estimates a plurality of regression models having different shapes, the analysis part 40 determines that there is a deficiency in the input first multi-dimensional data (that is, multi-dimensional data to be analyzed).

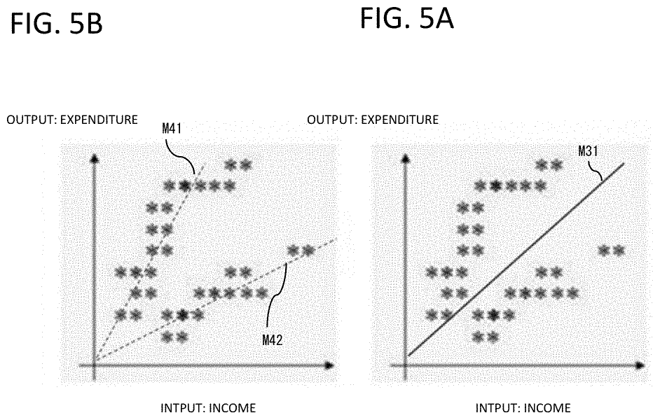

Next, with reference to FIGS. 5A and 5B, an example in a case where types of input data are insufficient (that is, there is a deficiency in a data of multi-dimensional data) will be described. In FIGS. 5A and 5B, it is assumed that a horizontal axis shows income and a vertical axis shows expenditure. In FIGS. 5A and 5B, a personal income and an expenditure are plotted by points “*” (multi-dimensional data) in a graph. It is assumed that an expenditure is estimated from a personal income based on the multi-dimensional data as show in FIGS. 5A and 5B.

For example, in a case where interpolation is performed in such manner that an error from a regression model with respect to entire multi-dimensional data becomes small, a regression model like a straight line M31 as shown in FIG. 5A is estimated. When the regression model is a straight line M31 as shown in FIG. 5A, in most area of the multi-dimensional data, errors from the multi-dimensional data are larger than those in a case of regression models (straight lines M41 and M42) as shown in FIG. 5B, and in addition it is not possible to find out that types of data are insufficient.

On the other hand, the data analysis apparatus 1 according to the present example embodiment becomes easy to fall into a local solution in linear interpolation. As a result, the data analysis apparatus 1 according to the present example embodiment can estimate regression models like straight lines M41 and M42 as shown in FIG. 5B. Therefore, the data analysis apparatus 1 according to the present example embodiment can indicate that there are two models between the personal income and expenditure as shown in FIG. 5B. Here, as shown in FIG. 5B, presence of two models means that two different expenditures are forecasted from a personal income. In such case, it is difficult to make an appropriate action plan based on a personal income. Therefore, as shown in FIG. 5B, the data analysis apparatus 1 determines that there is a deficiency in data in the multi-dimensional data when it has estimated two different regression models. Note, the data analysis apparatus 1 according to the present example embodiment can perform precise regression by performing multiple times estimation of a regression model and a processing of determining whether or not there is a deficiency in data based on an estimation result of a regression model. In that case, it is preferable for the data analysis apparatus 1 according to the present example embodiment to determine whether or not there is a deficiency in data based on the fewer number of regression models with less error.

As described above, the data analysis apparatus 1 according to the present example embodiment can interpolate data so as to be easy to fall into a local solution by dividing and interpolating a multi-dimensional space spanned by multi-dimensional data. Furthermore, the data analysis apparatus 1 according to the present example embodiment 1 determines that there is a deficiency in data in an input multi-dimensional data if it estimates a plurality of different regression models. In other words, the data analysis apparatus 1 according to the present example embodiment determines that the input multi-dimensional data is running short of necessary information if it estimates a plurality of different regression models. Therefore, the data analysis apparatus 1 according to the present example embodiment contributes to expect that types of input data are insufficient. Therefore, the data analysis apparatus 1 according to the present example embodiment contributes to avoid an erroneous action plan based on insufficient data from being made. Therefore, the data analysis apparatus 1 according to the present example embodiment contributes to assist a person in making appropriate action plans based on multi-dimensional data.

Next, a hardware configuration of a data analysis apparatus 1 will be described.

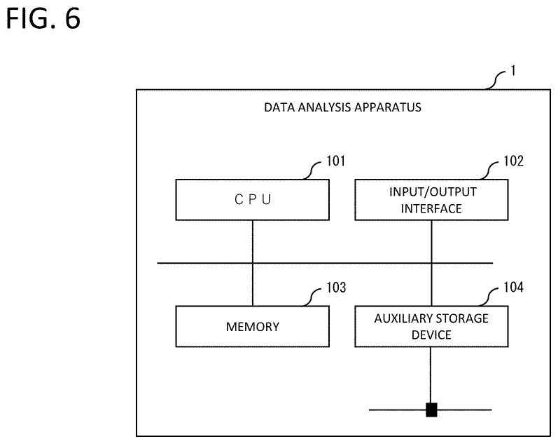

FIG. 6 shows a block diagram illustrating an example of a hardware configuration of the data analysis apparatus 1. The data analysis apparatus 1 can be configured by a computer and includes a configuration shown in FIG. 6. For example, the data analysis apparatus 1 includes a CPU (Central Processing Unit) 101, an input/output interface 102, a memory 103 and an auxiliary storage device 104 and so on, which are connected each other by an internal bus.

A function of the data analysis apparatus 1 is realized by the CPU 101 reading out multi-dimensional data stored in the auxiliary storage device 104 and executing a program stored in the memory 103. That is, the CPU 101 may execute a division processing program, an interpolation processing program, and an estimation processing program of an analysis model stored in a memory 103.

The input/output interface 102 is a display or an interface of an input apparatus. The input apparatus is a keyboard, a touch panel and so on.

The disclosure of the above Patent Literatures is incorporated herein by reference thereto and is considered to be described therein, and can be used as a basis and a part of the present invention if needed. Variations and adjustments of the example embodiments and examples are possible within the scope of the overall disclosure (including the claims) of the present invention and based on the basic technical concept of the present invention. Various combinations and selections (including partial deletion) of various disclosed elements (including the elements in each of the claims, example embodiments, examples, drawings, etc.) are possible within the scope of the entire disclosure of the present invention. Namely, the present invention of course includes various variations and modifications that could be made by those skilled in the art according to the overall disclosure including the claims and the technical concept. In particular, with respect to the numerical ranges described herein, any numerical values or small range(s) included in the ranges should be construed as being expressly described even if not particularly mentioned. In the present invention, it is obvious that a computer is used in a case where an algorithm, a software, and a flowchart or automated process steps are indicated and also obvious that a computer is equipped with a processor and a memory or a storage device. If those are not definitely described, the present invention is construed that those elements are of course described.

### REFERENCE SIGNS LIST

1, 1000 data analysis apparatus
10 storage part
20, 1001 input part
30, 1002 calculation part
31 division part
32 interpolation part
40, 1003 analysis part
101 CPU
102 input/output interface
103 memory
104 auxiliary storage device

What is claimed is:

1-10. (canceled)

11. A data analysis apparatus, comprising:
an input part which receives first multi-dimensional data made up by a set of multi-dimensional vectors;
a calculation part a calculation part which divides a first multi-dimensional space spanned by the first multi-dimensional data into a second multi-dimensional space(s), interpolates second multi-dimensional data forming the second multi-dimensional space(s) among the first multi-dimensional data, and estimates a regression model(s) of the second multi-dimensional data; and
an analysis part which determines whether or not there is a deficiency in the first multi-dimensional data based on the regression model(s).

12. The data analysis apparatus according to claim 11, wherein the analysis part determines that there is a deficiency in the first multi-dimensional data if the calculation part estimates a plurality of different regression models.

13. The data analysis apparatus according to claim 11, wherein the calculation part interpolates the second multi-dimensional data using a loss function and estimates a model which minimizes a sum of the loss functions as a regression model.

14. The data analysis apparatus according to claim 11, wherein the calculation part determines a gradient of the loss function to be minimized by a monotonically decreasing function with respect to a distance from the second multi-dimensional data, optimizes parameters related to a linear interpolation using a stochastic gradient descent method based on the gradient, and estimates the regression model.

15. The data analysis apparatus according to claim 11, wherein the analysis part determines whether or not to re-estimate a regression model based on the regression model.

16. The data analysis apparatus according to claim 11, wherein the analysis part removes, from the first multi-dimensional data, the multi-dimensional vector(s) whose distance from the regression model is less than or equal to a predetermined distance among the first multi-dimensional data, and if a ratio of the remaining first multi-dimensional data to the first multi-dimensional data received by the input part becomes less than or equal to a predetermined rate, terminates estimation of a regression model.

17. The data analysis apparatus according to claim 11, wherein the analysis part terminates estimation of a regression model if the number of estimated regression models exceeds a predetermined number.

18. The data analysis apparatus according to claim 11, wherein the calculation part randomly determines a parameter(s) related to a division of the first multi-dimensional space when the first multi-dimensional space is divided for the first time and, when the first multi-dimensional space is divided for the second or subsequent times, adjusts an adoption probability of a parameter(s) related to a division of the first multi-dimensional space in response to a value of a loss function corresponding to the second multi-dimensional space(s) divided up until a previous time.

19. A data analysis method, comprising:
receiving first multi-dimensional data made up by a set of multi-dimensional vectors;
dividing a first multi-dimensional space spanned by the first multi-dimensional data into a second multi-dimensional space(s);
interpolating second multi-dimensional data forming the second multi-dimensional space(s) among the first multi-dimensional data;
estimating a regression model(s) of the second multi-dimensional data; and
determining whether or not there is a deficiency in the first multi-dimensional data based on the regression model(s).

20. A non-transient computer readable medium storing a program that causes a computer to execute processings, comprising:
receiving first multi-dimensional data made up by a set of multi-dimensional vectors;
dividing a first multi-dimensional space spanned by the first multi-dimensional data into a second multi-dimensional space(s);
interpolating second multi-dimensional data forming the second multi-dimensional space(s) among the first multi-dimensional data;
estimating a regression model(s) of the second multi-dimensional data; and
determining whether or not there is a deficiency in the first multi-dimensional data based on the regression model(s).

21. The data analysis method according to claim 19, comprising:
determining that there is a deficiency in the first multi-dimensional data if the calculation part estimates a plurality of different regression models.

22. The data analysis method according to claim 19, comprising:
interpolating the second multi-dimensional data using a loss function; and
estimating a model which minimizes a sum of the loss functions as a regression model.

23. The data analysis method according to claim 19, comprising:
determining a gradient of the loss function to be minimized by a monotonically decreasing function with respect to a distance from the second multi-dimensional data;
optimizing parameters related to a linear interpolation using a stochastic gradient descent method based on the gradient; and
estimating the regression model based on the parameter.

24. The data analysis method according to claim 19, comprising:
determining whether or not to re-estimate a regression model based on the regression model.

25. The data analysis method according to claim 19, comprising:
removing, from the first multi-dimensional data, the multi-dimensional vector(s) whose distance from the regression model is less than or equal to a predetermined distance among the first multi-dimensional data; and
terminating estimation of the regression model if a ratio of the remaining first multi-dimensional data to the first multi-dimensional data received by the input part becomes less than or equal to a predetermined rate.

26. The data analysis method according to claim 19, comprising:
terminating estimation of a regression model if the number of estimated regression models exceeds a predetermined number.

27. The data analysis method according to claim 19, comprising:
determining randomly a parameter(s) related to a division of the first multi-dimensional space when the first multi-dimensional space is divided for the first time; and
adjusting an adoption probability of a parameter(s) related to a division of the first multi-dimensional space in response to a value of a loss function corresponding to the second multi-dimensional space(s) divided up until a previous time when the first multi-dimensional space is divided for the second or subsequent times.

28. The non-transient computer readable medium storing a program that causes a computer to execute processings according to claim 20, comprising:
determining that there is a deficiency in the first multi-dimensional data if the calculation part estimates a plurality of different regression models.

29. The non-transient computer readable medium storing a program that causes a computer to execute processings according to claim 20, comprising:
interpolating the second multi-dimensional data using a loss function; and
estimating a model which minimizes a sum of the loss functions as a regression model.

30. The non-transient computer readable medium storing a program that causes a computer to execute processings according to claim 20, comprising:
determining a gradient of the loss function to be minimized by a monotonically decreasing function with respect to a distance from the second multi-dimensional data;
optimizing parameters related to a linear interpolation using a stochastic gradient descent method based on the gradient; and
estimating the regression model based on the parameter.
